(19) United States
(12) Patent Application Publication
(10) Pub. No.: US 2026/0012993 A1
(43) Pub. Date: Jan. 8, 2026

(54) ENABLING IMPROVED MULTI-LINK RECONFIGURATION WHEN DELETING CURRENT LINK

(71) Applicant: Cisco Technology, Inc., San Jose, CA (US)

(72) Inventors: Binita Gupta, San Diego, CA (US); Brian Hart, Sunnyvale, CA (US)

(21) Appl. No.: 19/260,070

(22) Filed: Jul. 3, 2025

Related U.S. Application Data
(60) Provisional application No. 63/668,706, filed on Jul. 8, 2024.

(51) Int. Cl. H04W 76/15; H04W 72/0446; H04W 76/18

(52) U.S. Cl. CPC H04W 76/15; H04W 72/0446; H04W 76/18

(57) ABSTRACT

In various embodiments described herein methods, systems, and devices for facilitating improved multi-link reconfiguration, the method includes constructing a link reconfiguration request frame, transmitting the link configuration request frame, receiving a link reconfiguration response frame, processing the received link configuration response frame, transmitting an acknowledgment frame, and transitioning link operations.

### CROSS-REFERENCE TO RELATED APPLICATION

This application claims the benefit of priority to U.S. Provisional Application No. 63/668,706, filed Jul. 8, 2024, the disclosure of which is incorporated by reference herein in its entirety.

The present disclosure relates to wireless networking. More particularly, the present disclosure relates to addressing a gap for Multi-Link (ML) Reconfiguration add/delete links operation when a current link is being deleted to avoid Access Point (AP) ML Device (MLD) and non-Access Point (non-AP) MLD becoming out of sync with regard to their state for the setup links.

### BACKGROUND

Wi-Fi, or wireless fidelity, is of paramount importance in the modern era as a ubiquitous technology that enables wireless connectivity for a wide range of devices. Its significance lies in providing convenient and flexible internet access, allowing seamless communication, data transfer, and online activities. Wi-Fi has become a cornerstone for connectivity in homes, businesses, public spaces, and educational institutions, enhancing productivity and connectivity for individuals and organizations alike.

Over time, the importance of Wi-Fi has evolved in tandem with technological advancements. The increasing demand for faster speeds, greater bandwidth, and improved security has driven the development of more advanced Wi-Fi standards. However, as technology progresses, the demands of Wi-Fi standards and technologies require increasing evolution and innovations in order to provide enhanced performance, increased capacity, and better efficiency.

One such evolution in recent wireless standards is the introduction of more complex features designed to manage network resources more dynamically. For example, advanced features like Multi-Link Operation (MLO) allow a single device to use multiple radio links or channels simultaneously. This capability can significantly increase data throughput and improve reliability by providing redundant communication paths. However, the management of these multiple links, which can involve dynamically adding, deleting, or switching between them, requires sophisticated and highly reliable communication protocols between network devices to ensure a seamless and uninterrupted user experience.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a conceptual depiction of a communication layer architecture in accordance with various embodiments of the disclosure, in accordance with various embodiments of the disclosure;

FIG. 3 is a conceptual network diagram of various environments that a link reconfiguration logic may operate on a plurality of network devices, in accordance with various embodiments of the disclosure;

FIG. 4 is a conceptual illustration of a multi-link configuration setup, in accordance with various embodiments of the disclosure;

FIG. 5 is a timing diagram depicting communication between a non-access point multi-link device and an access point mutli-link device on a specific link, in accordance with various embodiments of the disclosure;

FIG. 6 is a flowchart depicting a process for synchronizing states, in accordance with various embodiments of the disclosure;

FIG. 7 is a flowchart depicting a process for non-access point multi-link device synchronization, in accordance with various embodiments of the disclosure;

FIG. 8 is a flowchart depicting a process for access point multi-link device synchronization, in accordance with various embodiments of the disclosure; and

FIG. 9 is a conceptual block diagram of a device suitable for configuration with a link reconfiguration logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

### Overview

In some embodiments, a device, includes a processor, at least one network interface controller configured to provide access to a network via a plurality of ports, and a memory communicatively coupled to the processor, wherein the memory includes a link reconfiguration logic. The logic is configured to receive the link configuration request frame, transmit an acknowledgment frame, evaluate the link reconfiguration request, transmit a link reconfiguration response frame, monitor for an acknowledgment frame, detect a failure to receive the acknowledgment frame, attempt to retransmit the link reconfiguration response frame on an original link, and initiate a selected synchronization assurance mechanism.

In some embodiments, a method of facilitating improved multi-link reconfiguration, the method includes constructing a link reconfiguration request frame, transmitting the link configuration request frame, receiving a link reconfiguration response frame, processing the received link configuration response frame, transmitting an acknowledgment frame, and transitioning link operations.

### EXAMPLE EMBODIMENTS

802.11be defines ML reconfiguration optional for adding and deleting links to the setup links of a non-AP MLD. ML Reconfiguration may be achieved by a non-AP MLD sending a Link Reconfiguration Request frame and the AP MLD responding with a Link Reconfiguration Response frame. This results in the non-Access Point (non-AP) Multi-Link Device (MLD) and the Access Point (AP) Multi-Link Device (MLD) being out of sync in terms of setup links for that non-Access Point (non-AP) Multi-Link Device (MLD). It is important to solve this error case for robust operation of Multi-Link (ML) Reconfiguration add/delete links feature. In response to the issues described above, devices and methods are discussed herein to address a gap for Multi-Link (ML) Reconfiguration add/delete links operation when a current link is being deleted to avoid an Access Point (AP) Multi-Link Device (MLD) and a non-Access Point (non-AP) Multi-Link Device (MLD) becoming out of sync with regard to their state for the setup links.

In general, wireless networking standards such as 802.11be may define optional multi-link (ML) reconfiguration for adding and deleting links to the setup links of a non-access point multi-link device (non-AP MLD). For example, a non-AP MLD could perform various ML reconfiguration operations. Such operations may include adding a new link, such as by changing from a single link A to a combination of links A and B, or adding multiple new links, such as by changing from link A to a combination of links A, B, and C. In certain embodiments, the operations may involve deleting a current link while adding one or more new links, such as by changing from link A to link B, or from link A to a combination of links B and C. It is also contemplated that the operation may involve modifying an existing multi-link setup, such as by changing from links A and B to links B and C, which involves deleting the current link A while adding a new link C.

In additional embodiments, ML Reconfiguration may be achieved by a non-AP MLD sending a Link Reconfiguration Request frame and the AP MLD responding with a Link Reconfiguration Response frame. In the ML Reconfiguration operations where the current link is being deleted and replaced by one or more other links, as in the latter examples above, there may be an error possibility that the transaction does not get completed. For instance, a typical transaction may involve a first step where a non-AP MLD sends a Link Reconfiguration Request frame on a first link, a second step where the AP MLD sends an acknowledgment (ACK) for the request on the first link, a third step where the AP MLD sends a Link Reconfiguration Response frame on the first link, and a fourth step where the non-AP MLD sends an ACK for the response on the first link.

In embodiments where the final ACK frame from the non-AP MLD is lost and is not received by the AP MLD, the AP MLD may retry sending the Link Reconfiguration Response frame on the original link. However, because the non-AP MLD may have already processed the initial response and ceased operating on that link as part of the deletion process, it may not receive the retried frame. This may result in the non-AP MLD and the AP MLD becoming out of sync in terms of their understanding of the active setup links for that non-AP MLD. It is important to solve this error case to ensure robust operation of the Multi-Link Reconfiguration add/delete links feature.

In many embodiments, to resolve this issue, an AP MLD may be allowed to send a Link Reconfiguration Response frame over other links. For example, the ML Reconfiguration feature may be enhanced such that in scenarios where a link reconfiguration results in a non-AP MLD deleting its current link, if the AP MLD does not get an ACK for its Link Reconfiguration Response frame, it can choose to send the Link Reconfiguration Response frame on one or more of the new setup links that were indicated as successfully added. The Link Reconfiguration Response frame sent on other links may have the same Dialog Token as the one received in the corresponding Link Reconfiguration Request frame to ensure the messages are correctly associated. In additional embodiments, the AP MLD may decide to send the Link Reconfiguration Response frame on a newly added link where it has already received another frame from the non-AP MLD, as this may indicate that the non-AP MLD is active on that link.

In still additional embodiments, when a non-AP MLD receives a Link Reconfiguration Response frame on a new or different link, it may check for a matching Dialog Token to associate it with a Link Reconfiguration Request frame that it had sent previously on another link. Upon finding a match, the non-AP MLD may send an ACK for that frame on the new link. When the AP MLD receives this ACK, it can confirm the transaction is complete and update its internal records for the non-AP MLD's setup links. As a result, both the AP MLD and non-AP MLD may achieve the same, synchronized state for the setup links.

In various embodiments, a specific behavior may be defined for the AP MLD and the non-AP MLD. An AP MLD may send the Link Reconfiguration Response frame on the same link where the corresponding Link Reconfiguration Request frame was received, except in the specific failure case. For example, if the AP MLD does not receive an acknowledgement for a Link Reconfiguration Response frame that requested deletion of the link where the frame exchange occurred, and the link deletion was otherwise successful, then the AP MLD may also send the same Link Reconfiguration Response frame on any of the new setup links that were indicated as successfully added. Similarly, if a non-AP MLD receives a Link Reconfiguration Response frame on a different link than the link where the corresponding request was sent, as identified by a matching Dialog Token, it may send an acknowledgement for that frame.

In other additional embodiments, an “ML Reconfig Switch Time” field may be added in the Link Reconfiguration Response frame. This field may indicate a future time when the new set of setup links become active. This may ensure that the non-AP MLD remains on the current link for a bit longer, allowing any error scenarios where an AP MLD retries the Link Reconfiguration Response frame on the current link to be handled by the non-AP MLD, which can then send an ACK for the retried frame. The ‘ML Reconfig Switch Time’ field can indicate a switch time for the ML reconfiguration in various units, such as Time Units (TUs), where one TU may equal 1024 microseconds, or as a power of two multiple or sub-multiple of a TU, or in milliseconds.

For example, the ‘ML Reconfig Switch Time’ field can be included at the end of the Link Reconfiguration Response frame, perhaps encapsulated in its own sub-element. Alternatively, the new field can be included in any other place in the frame or as part of another existing field or element. In still additional embodiments, the non-AP MLD can also indicate its preference for an ‘ML Reconfig Switch Time’ in the Link Reconfiguration Request frame. The AP MLD can then indicate the same ‘ML Reconfig Switch Time’ in its response, or it may provide a different time if its own operational needs require it.

In many further embodiments, an AP MLD may send a BSS Transition Management (BTM) Request to reinitiate the ML Reconfiguration procedure. For example, if the AP MLD does not get an ACK for the Link Reconfiguration Response frame after some retries, it may assume an error has occurred and can send a BTM Request frame on both the old and/or new set of setup links indicating the desired set of links. This BTM Request frame can be enhanced, for example by using a reserved bit in the Request Mode, to indicate that an ‘ML Reconfig Requested’ is being made.

If, based on its local state, the non-AP MLD is already operating on the suggested set of setup links received in the BTM Request, it can take one or more actions. For example, in many embodiments, it may assume the previous ML Reconfiguration operation did not succeed at the AP and revert its setup links to the old set of links and re-perform the same operation. In other instances, it may send a BTM Response frame with a new BTM Status Code to indicate that the non-AP MLD is “already operating on suggested setup links”. The AP MLD can take that as an indication that the previous ML Reconfiguration was successful at the non-AP MLD and update its own setup links for that non-AP MLD. Alternatively, a non-AP MLD could send a BTM Response with “Accept,” which could also signal to the AP MLD that the previous reconfiguration was successful.

In still additional embodiments, the ML Reconfiguration procedure itself may be enhanced to support a ‘report’ setup link operation, in addition to add and delete link operations. A non-AP MLD can initiate an ML Reconfiguration procedure by sending a Link Reconfiguration Request frame that reports the current state of its setup links. This request may be sent using protected management frames for security. The AP MLD can then update its state to match that of the non-AP MLD. The AP MLD may then respond with a Link Reconfiguration Response frame that indicates SUCCESS for each of the setup links reported by the non-AP MLD. It should be understood that any of the foregoing examples may address the out-of-sync state between the AP MLD and the non-AP MLD.

In certain embodiments, a non-AP MLD may send a frame with a Power Management (PM) bit set to zero on one of the newly added links. For example, after sending an ACK for the Link Reconfiguration Response frame that deletes the current link, the non-AP MLD may send another frame, such as a QoS Null frame, with PM=0 on any of the newly added links soon after. If the reconfiguration changes the link from A to B, the non-AP MLD may send the frame on link B. If the change is from A to links B and C, it may send the frame on either B or C. In general, it is envisioned that the frame signaling PM=0 is sent as a protected frame. This may signal to the AP MLD that the ML Reconfiguration operation was completed successfully at the non-AP MLD, allowing the AP MLD to update its setup links accordingly, even if the original ACK was lost.

In some embodiments, as a last resort, the AP MLD may disassociate the non-AP MLD. If the AP MLD does not receive an ACK for the Link Reconfiguration Response frame after some retries, it may assume a persistent error condition has occurred and may disassociate the non-AP MLD by sending a Disassociation frame over both the old and the new set of links. In such a case, the non-AP MLD would have to reassociate with the AP MLD to re-establish a connection.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

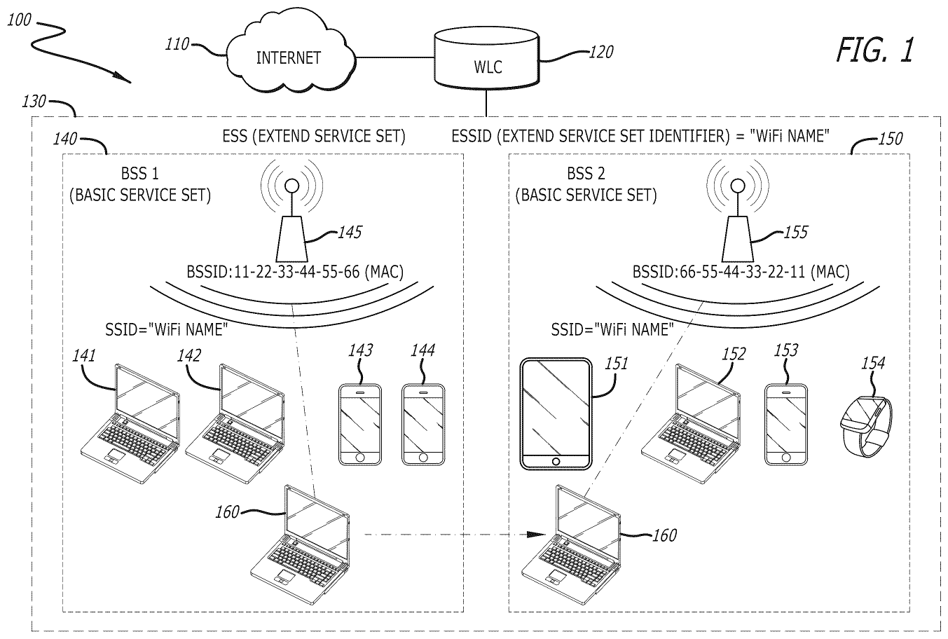

Referring to FIG. 1, a schematic block diagram of a wireless local networking system 100, in accordance with various embodiments of the disclosure is shown. The wireless local networking system 100 may represent a typical environment where various devices, which may comprise a processor, memory, and at least one network interface controller, can operate and communicate. In many embodiments, the wireless local networking system 100 can connect to a wider public network, such as the Internet 110, through a management device like a wireless network controller (WLC 120). The WLC 120 may be communicatively coupled to an extended service set (ESS 130), which can provide a unified wireless network for a plurality of user devices to connect to and perform network operations, such as to transition and/or reconfigure one or more link operations.

In various embodiments, the ESS 130 may be configured to provide seamless network coverage over a large area through the use of one or more basic service sets (BSS), such as a first BSS 140 and a second BSS 150. The ESS 130 may be identified by an extended service set identifier (ESSID), shown here as “WiFi Name.” This architecture can facilitate reliable communication for devices that may need to construct and transmit various management frames. For example, a device within the ESS 130 may be configured to transmit a link reconfiguration request frame to an access point to modify its connection state.

In some embodiments, the first BSS 140 may be coordinated by a first access point 145 and identified by a unique basic service set identifier (BSSID). The first access point 145 may be a device configured to receive a link configuration request frame and, in response, transmit an acknowledgment frame and subsequently transmit a link reconfiguration response frame. A plurality of user devices, such as a first notebook 141, a second notebook 142, a first phone 143, and a second phone 144, may associate with the first access point 145. Each of these user devices may be an embodiment of a device comprising a link reconfiguration logic configured to process a received link configuration response frame and transmit an acknowledgment frame for it.

In additional embodiments, the second BSS 150, coordinated by a second access point 155, may also support a plurality of user devices, including a first tablet 151, a fourth notebook 152, a third phone 153, and a first watch 154. The embodiment depicted in FIG. 1 shows a third notebook 160 that is communicatively coupled to both the first BSS 140 and the second BSS 150. Such a device may be a multi-link device that needs to reconfigure link operations, for instance, by sending a link reconfiguration request frame that proposes the deletion of a current communication link. To ensure a stable transition in such a scenario, the device's link reconfiguration logic may be configured to execute a proactive synchronization measure after transitioning link operations, such as by transmitting a frame with a power management bit set to zero on a newly added link.

In further embodiments, the first access point 145 and the second access point 155, or the WLC 120, may be configured with a link reconfiguration logic designed to manage these operations from the network side. This logic may be configured to monitor for an acknowledgment frame from a user device and to detect a failure to receive the acknowledgment frame within a certain period. Upon detecting such a failure, the logic may attempt to retransmit the link reconfiguration response frame on an original link and, if that is unsuccessful or if a specific policy is met, initiate a selected synchronization assurance mechanism to resolve any potential out-of-sync states with the user device.

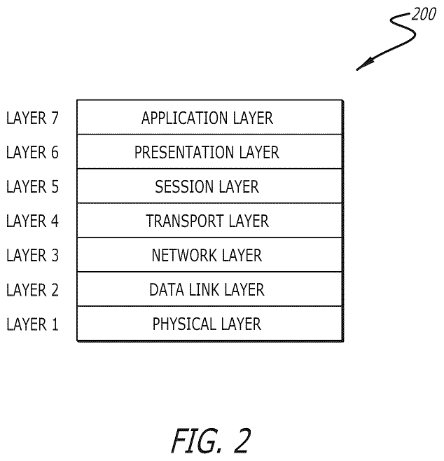

Although a specific embodiment for a wireless local networking system 100 for carrying out the various steps, processes, methods, and operations described herein is discussed with respect to FIG. 1, any of a variety of systems and/or devices may be utilized in accordance with embodiments of the disclosure. For example, the first access point 145 and the second access point 155 may be configured as access point multi-link devices (AP MLDs) and the various user devices may be configured as non-access point multi-link devices (non-AP MLDs) capable of executing the link reconfiguration logic. The elements depicted in FIG. 1 may also be interchangeable with other elements of FIGS. 2-9 as required to realize a particularly desired embodiment.

Referring to FIG. 2, a conceptual depiction of a communication layer architecture 200, in accordance with various embodiments of the disclosure is shown. In many embodiments, the communication layer architecture 200 can be configured as a conceptual model, such as the Open Systems Interconnection (OSI) model, that standardizes the functions of a telecommunication or computing system. This layered framework can be used to describe the complex network interactions involved in multi-link reconfigurations, from the physical transmission of signals to the application-level logic that governs the process.

In some embodiments, the first layer of the communication layer architecture 200 may be the Physical Layer. This foundational layer can be responsible for the transmission and reception of raw, unstructured data bits over a physical medium, such as cables or wireless connections. In the context of the devices described herein, the at least one network interface controller may operate at this layer to handle the electrical, mechanical, and procedural characteristics of the hardware required to send and receive signals over a network. The primary goal of the Physical Layer may be to establish a reliable and efficient means of physically transmitting the data that constitutes the various frames used in link reconfiguration.

In further embodiments, the second layer may be the Data Link Layer. This layer may be primarily concerned with the reliable and efficient transmission of data between directly connected devices over a particular physical link. Its responsibilities can include framing data into frames, physical addressing (such as Media Access Control or MAC addressing), and error detection. It is at this layer that a link reconfiguration request frame may be constructed and an acknowledgment frame may be transmitted to confirm receipt. The process to reconfigure link operations from a current communication link to a new link is fundamentally a Layer 2 operation.

In additional embodiments, the third layer may be the Network Layer. This layer can be a pivotal component responsible for providing logical addressing, such as Internet Protocol (IP) addressing, and for establishing end-to-end communication by routing packets across interconnected networks. While the link reconfiguration itself may be a link-layer procedure between an access point multi-link device and a non-access point multi-link device, this layer can ensure that the devices themselves can communicate within the larger network topology.

In various embodiments, the fourth layer may be the Transport Layer, a critical element responsible for end-to-end communication and reliable delivery of data between processes on host devices. Its primary objectives can include error detection and correction, flow control, and the segmentation and reassembly of data. Protocols at this layer can ensure that a sequence of messages, such as a request and a subsequent response, are delivered reliably. The concept to monitor for an acknowledgment frame and detect a failure to receive the acknowledgment frame is analogous to reliability mechanisms often managed at the Transport Layer.

In certain embodiments, the fifth layer may be the Session Layer. This layer can be configured to manage and control communication sessions or dialogues between applications. The entire multi-link reconfiguration transaction-from the initial request to the final synchronization of link states-can be viewed as a session. The Session Layer can provide mechanisms for establishing, maintaining, and terminating these dialogues, ensuring that the exchange of information is synchronized and orderly. The use of a Dialog Token to match a response with a request, as described in the disclosure, is a concept that aligns with the functions of this layer.

In many embodiments, the sixth layer may be the Presentation Layer, which can focus on the representation and translation of data to ensure that information is presented in a standardized and understandable manner for both the sending and receiving devices. This layer may be responsible for data format conversion and, importantly, data encryption. The requirement that certain management frames for link reconfiguration be sent as protected frames involves services that can be managed at the Presentation Layer to ensure the security and integrity of the transmitted link reconfiguration response frame and other sensitive data.

Finally, the seventh layer may be the Application Layer, which serves as the interface between the network and the software applications that end-users and network administrators interact with. The link reconfiguration logic itself, which is configured to evaluate the link reconfiguration request and initiate a selected synchronization assurance mechanism, can be considered an application-layer function. This logic makes intelligent decisions based on the state of the network and the communication protocol, and it represents the highest level of control in the processes described herein.

Although a specific embodiment for a communication layer architecture 200 is described above with respect to FIG. 2, any of a variety of systems and/or processes may be utilized in accordance with embodiments of the disclosure. For example, while the seven-layer OSI model is depicted, other networking models, such as the TCP/IP model, which consolidates some of these layers, may also be used to describe the communication processes herein. The elements depicted in FIG. 2 may also be interchangeable with other elements of FIG. 1 and FIGS. 3-9 as required to realize a particularly desired embodiment.

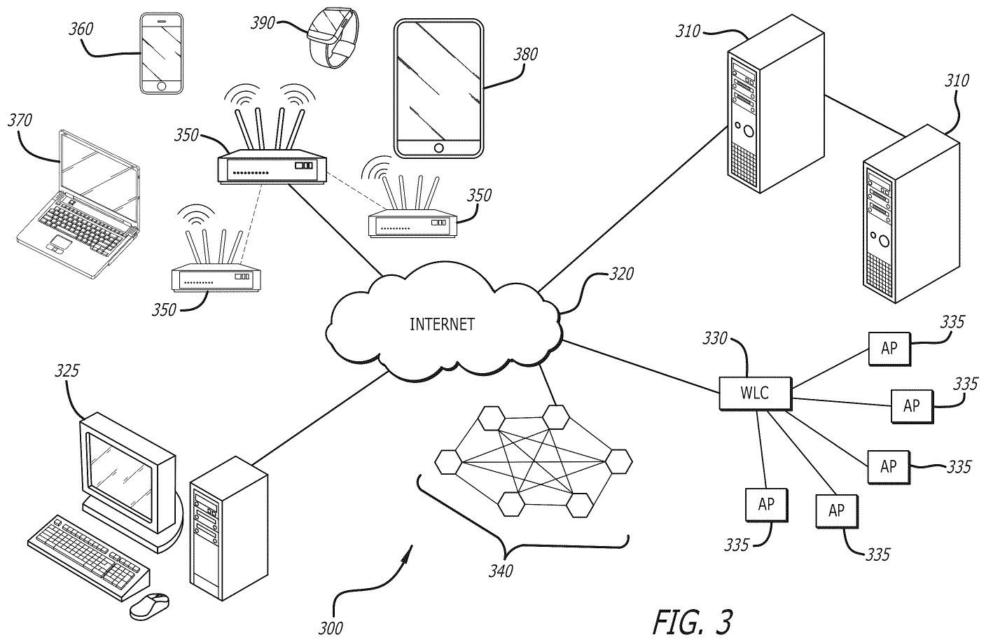

Referring to FIG. 3, a conceptual network diagram 300 of various environments that a link reconfiguration logic may operate on a plurality of network devices, in accordance with various embodiments of the disclosure is shown. Those skilled in the art will recognize that the link reconfiguration logic can include various hardware and/or software deployments and can be configured in a variety of ways. The conceptual network diagram 300 illustrates that this logic can be centralized, distributed, or remotely operated as part of a cloud-based network management tool, providing flexibility for network architects and administrators.

In many embodiments, the link reconfiguration logic may be configured to operate on one or more servers 310. The one or more servers 310 may be connected to a communication network 320, such as the Internet, and can provide the logic as a cloud-based service to manage one or more remote deployed networks 340. In such a configuration, one or more servers 310 could function as a device configured to receive a link configuration request frame from a distant non-access point multi-link device, evaluate the link reconfiguration request, and orchestrate the transmission of a link reconfiguration response frame.

In additional embodiments, the link reconfiguration logic may be operated as a distributed logic across multiple network devices. In the embodiment depicted in FIG. 3, a plurality of home network access points (home APs 350) can operate as a distributed system, where one AP may have the link reconfiguration logic, or they may all work in tandem. These home APs 350 can facilitate Wi-Fi connections for various electronic devices, such as, but not limited to, mobile computing devices including laptop computers 370, cellular phones 360, portable tablet computers 380, and wearable computing devices 390. Any of these home APs 350 could be the device that is configured to monitor for an acknowledgment frame and detect a failure to receive it, while any of the user devices (such as cellular phones 360, laptop computers 370, portable tablet computers 380, wearable computing devices 390) could be the device that is configured to construct a link reconfiguration request frame and reconfigure link operations.

In further embodiments, the link reconfiguration logic may be integrated within another network device. In the embodiment depicted in FIG. 3, a wireless LAN controller (WLC 330) may have an integrated link reconfiguration logic. The WLC 330 can use this logic to manage the multi-link operations for all the APs 335 that it is connected to. For example, the WLC 330 could initiate a selected synchronization assurance mechanism, such as instructing APs 335 to transmit a BSS Transition Management (BTM) request frame, if an out-of-sync condition is detected with a client device.

In still more embodiments, a personal computer 325 may be utilized to access and/or manage various aspects of the link reconfiguration logic, either remotely or within the network itself. In the embodiment depicted in FIG. 3, the personal computer 325 communicates over the communication network 320 and can access the link reconfiguration logic whether it resides on the one or more servers 310, the home APs 350, or the WLC 330.

Although a specific embodiment for various environments that the link reconfiguration logic may operate on a plurality of network devices suitable for carrying out the various steps, processes, methods, and operations described herein is discussed with respect to FIG. 3, any of a variety of systems and/or processes may be utilized in accordance with embodiments of the disclosure. For example, the link reconfiguration logic may be provided as a device or software separate from the WLC 330 or the link reconfiguration logic may be integrated into the WLC 330. The elements depicted in FIG. 3 may also be interchangeable with other elements of FIGS. 1-2 and FIGS. 4-9 as required to realize a particularly desired embodiment.

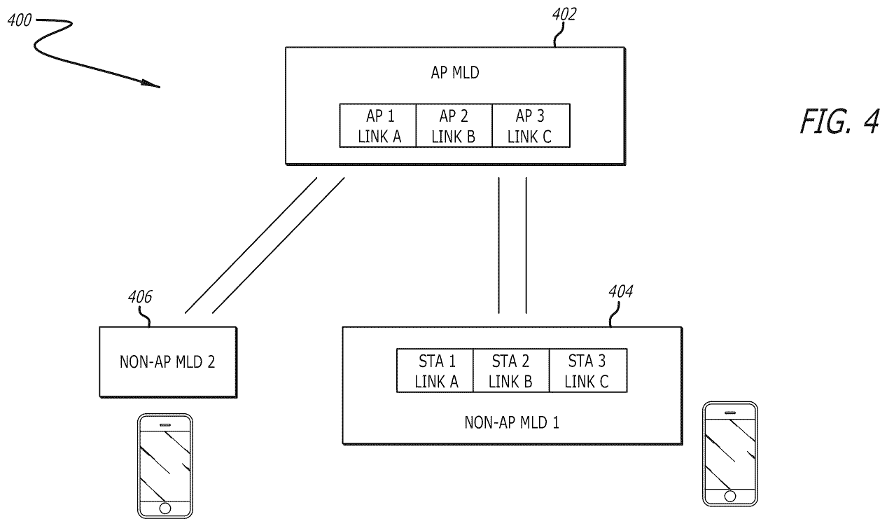

Referring to FIG. 4, a conceptual illustration of a multi-link configuration setup 400, in accordance with various embodiments of the disclosure is shown. The multi-link configuration setup 400 may depict the logical architecture and relationship between devices in a multi-link wireless environment. In many embodiments, the multi-link configuration setup 400 may include a central Access Point Multi-Link Device (AP MLD 402) that may be communicatively associated with one or more non-access point multi-link devices, such as a first non-access point multi-link device 404 (shown as non-AP MLD 1) and a second non-access point multi-link device 406 (shown as non-AP MLD 2).

In some embodiments, the AP MLD 402 may be a logical device that comprises multiple affiliated access point (AP) entities, with each AP entity configured to operate on a different communication link. As depicted in the embodiment shown in FIG. 4, the AP MLD 402 may include a first AP (AP 1) operating on a first link (Link A), a second AP (AP 2) operating on a second link (Link B), and a third AP (AP 3) operating on a third link (Link C). The AP MLD 402 may be an embodiment of a device comprising a link reconfiguration logic configured to manage the multi-link connections for its associated clients. For instance, this logic may be configured to receive a link configuration request frame from a device like the first non-AP MLD 1 404 and subsequently transmit a link reconfiguration response frame to approve or deny the requested changes.

In further embodiments, a non-AP MLD, such as the first non-AP MLD 1 404 or the second non-AP MLD 2 406, may be a client device such as a smartphone. A non-AP MLD may also be a logical device that comprises multiple affiliated station (STA) entities, with each STA entity configured to operate on a different link to communicate with a corresponding AP entity within the AP MLD 402. As shown in the embodiment, the first non-AP MLD 1 404 may include a first STA (STA 1) operating on the first link (Link A), a second STA (STA 2) operating on the second link (Link B), and a third STA (STA 3) operating on the third link (Link C). The non-AP MLD may be an embodiment of a device configured to construct a link reconfiguration request frame and, after a successful exchange, transition link operations by changing which of its affiliated STAs are active.

In additional embodiments, the communication between the AP MLD 402 and the first non-AP MLD 1 404 may represent a multi-link association that is managed by the link reconfiguration procedures described herein. The link reconfiguration process may allow the first non-AP MLD 1 404 to dynamically update the set of links that it has established with the AP MLD 402. For example, the first non-AP MLD 1 404 may use its first STA to transmit a link reconfiguration request frame on the first link that proposes the deletion of a current communication link (the first link) while requesting to add or maintain other links (such as the second link and the third link). It is in such a scenario, where the link used for the message exchange is itself being deleted, that a failure to receive an acknowledgment frame can lead to the out-of-sync conditions that various embodiments of the present disclosure aims to resolve.

Although a specific embodiment for a multi-link configuration setup 400 for carrying out the various steps, processes, methods, and operations described herein is discussed with respect to FIG. 4, any of a variety of systems and/or devices may be utilized in accordance with embodiments of the disclosure. For example, the links A, B, and C could correspond to different frequency bands such as 2.4 GHz, 5 GHZ, and 6 GHz, or could be different channels within the same frequency band. The elements depicted in FIG. 4 may also be interchangeable with other elements of FIGS. 1-3 and FIGS. 5-9 as required to realize a particularly desired embodiment.

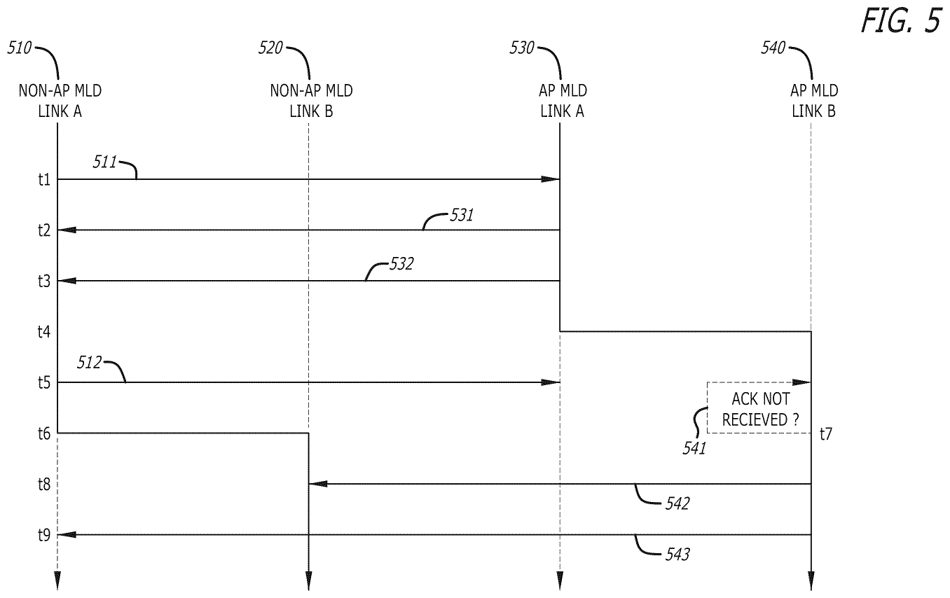

Referring to FIG. 5, a timing diagram 500 depicting communication between a non-access point multi-link device and an access point multi-link device on a specific link, in accordance with various embodiments of the disclosure is shown. The timing diagram 500 may illustrate a sequence of events over time between multiple entities involved in a multi-link reconfiguration process. In the depicted embodiment, four entities are shown: a non-access point multi-link device (non-AP MLD) on a first link 510 (Link A), a non-AP MLD on a second link 520 (Link B), an access point multi-link device (AP MLD) on the first link 530 (Link A), and an AP MLD on the second link 540 (Link B). The timing diagram 500 may specifically illustrate the problem scenario where a final acknowledgment is lost and may further illustrate one of the potential recovery procedures.

In many embodiments, the timing diagram 500 may begin at a first time t1 with the initiation of the link reconfiguration process. The non-AP MLD on the first link 510 may transmit a link reconfiguration request frame as part of a first message 511 to the AP MLD on the first link 530. This link reconfiguration request frame may propose the deletion of a current communication link, which in this case may be the first link. At a second time t2, the AP MLD on the first link 530 may receive the request and may transmit an acknowledgment frame back to the non-AP MLD on the first link 510 as part of a second message 531. Subsequently, at a third time t3, after the AP MLD has had an opportunity to evaluate the link reconfiguration request, it may transmit a link reconfiguration response frame as part of a third message 532.

In further embodiments, upon receiving and processing the link reconfiguration response frame, the non-AP MLD may prepare to finalize the transaction. At a fifth time t5, the non-AP MLD on the first link 510 may transmit an acknowledgment frame for the response as part of a fourth message 512. It is contemplated that this fourth message 512 may be lost in transit and is not successfully received by the AP MLD on the first link 530. Subsequent to transmitting the acknowledgment, the non-AP MLD may transition and/or reconfigure one or more of its link operations. As shown in the timing diagram 500 at a sixth time t6, this may involve the non-AP MLD ceasing its operations on the first link (e.g. because the first link was deleted in the link reconfiguration request) and activating (or continuing) its operations on the second link, as represented by the timeline for the non-AP MLD on the second link 520 beginning after the transmission of the fourth message 512.

In additional embodiments, the AP MLD may detect a failure to receive the acknowledgment frame that it was monitoring for. This detection may occur at a seventh time t7. As it is no longer certain of the state of the non-AP MLD, the AP MLD may attempt to retransmit the link reconfiguration response frame as a fifth message 542 on an original link at an eight time t8, but this may fail as the non-AP MLD is no longer operating on that link. In response to the detected failure, the AP MLD may be configured to initiate a selected synchronization assurance mechanism. For instance, at a ninth time t9 the AP MLD on the second link 540 may transmit a sixth message 543, such as a retransmitted link reconfiguration response frame, to the non-AP MLD on the second link 520. This represents one embodiment of a recovery procedure where the AP MLD attempts to communicate on the newly added link.

In certain embodiments, the non-AP MLD on the second link 520 may successfully receive the fifth message 542. In response, at a subsequent time, the non-AP MLD on the second link 520 may transmit a message (not shown), which may be an acknowledgment for the retransmitted frame, back to the AP MLD on the second link 540. Upon successful receipt of this message, both the AP MLD and the non-AP MLD may update their internal records to achieve a synchronized state, thereby successfully completing the link reconfiguration despite the initial lost acknowledgment. In some embodiments, this may be considered a proactive synchronization measure to confirm the synchronization of the link states.

Although a specific embodiment for a timing diagram 500 for carrying out the various steps, processes, methods, and operations described herein is discussed with respect to FIG. 5, any of a variety of systems and/or devices may be utilized in accordance with embodiments of the disclosure. For example, the frames used in the selected synchronization assurance mechanism on the second link could be other management frames, such as a BSS Transition Management (BTM) request frame, instead of a retransmitted link reconfiguration response frame. The elements depicted in FIG. 5 may also be interchangeable with other elements of FIGS. 1-4 and FIGS. 6-9 as required to realize a particularly desired embodiment.

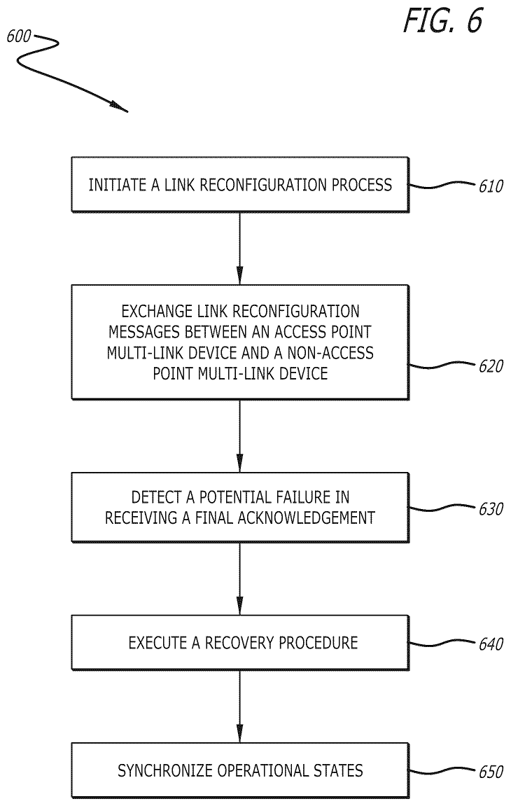

Referring to FIG. 6, a flowchart depicting a process 600 for synchronizing states, in accordance with various embodiments of the disclosure is shown. The process 600 may provide a high-level overview of a method for ensuring that two or more devices maintain a consistent understanding of their communication link states after a link reconfiguration, particularly in response to a potential communication failure.

In many embodiments, the process 600 can initiate a link reconfiguration process (block 610). For instance, the initiation may be performed by a non-access point multi-link device that seeks to modify its set of active communication links with an associated access point multi-link device. In some embodiments, the process may be initiated because the non-access point multi-link device detects that a new, higher-performance link has become available. It is contemplated that in other embodiments, the link reconfiguration process may be initiated in response to a request or recommendation from an access point multi-link device that is managing network-wide traffic or performance.

In a number of embodiments, the process 600 can exchange link reconfiguration messages between an access point multi-link device and a non-access point multi-link device (block 620). For example, this exchange can include a link reconfiguration request frame being transmitted by the non-access point multi-link device and a corresponding link reconfiguration response frame being transmitted by the access point multi-link device. In certain embodiments, the exchange of messages may also include the transmission and reception of one or more acknowledgment frames to confirm delivery of the request and response frames.

In more embodiments, the process 600 can detect a potential failure in receiving a final acknowledgement (block 630). This detection may be performed by an access point multi-link device after it has transmitted a link reconfiguration response frame and its link reconfiguration logic does not receive the expected acknowledgment frame within a pre-defined time period. In some embodiments, the potential failure may be detected by other means, such as if a non-access point multi-link device attempts to communicate on a new link before the access point multi-link device has confirmed the completion of the transaction, indicating a potential out-of-sync state.

In further embodiments, the process 600 can execute a recovery procedure (block 640). The recovery procedure may be an embodiment of a selected synchronization assurance mechanism that is initiated to resolve the ambiguity caused by the potential failure. For instance, the recovery procedure may comprise an access point multi-link device re-transmitting the link reconfiguration response frame on a newly added link instead of the original link. In other embodiments, the recovery procedure may involve a non-access point multi-link device executing a proactive synchronization measure, such as by transmitting a frame with a power management bit set to zero on a new link to signal its updated status.

In additional embodiments, the process 600 can synchronize operational states (block 650). This synchronization may be the outcome of the successful execution of the recovery procedure, resulting in both the access point multi-link device and the non-access point multi-link device having a consistent and accurate record of the active setup links. In some embodiments, after the operational states are synchronized, the non-access point multi-link device may seamlessly continue data transmission over the newly configured links without needing to perform a full re-association with the access point multi-link device.

Although a specific embodiment for a process 600 for synchronizing states for carrying out the various steps, processes, methods, and operations described herein is discussed with respect to FIG. 6, any of a variety of systems and/or devices may be utilized in accordance with embodiments of the disclosure. For example, the order of some operations could be varied, where a proactive recovery or confirmation procedure is executed by one device before a failure is formally detected by the other. The elements depicted in FIG. 6 may also be interchangeable with other elements of FIGS. 1-5 and FIGS. 7-9 as required to realize a particularly desired embodiment.

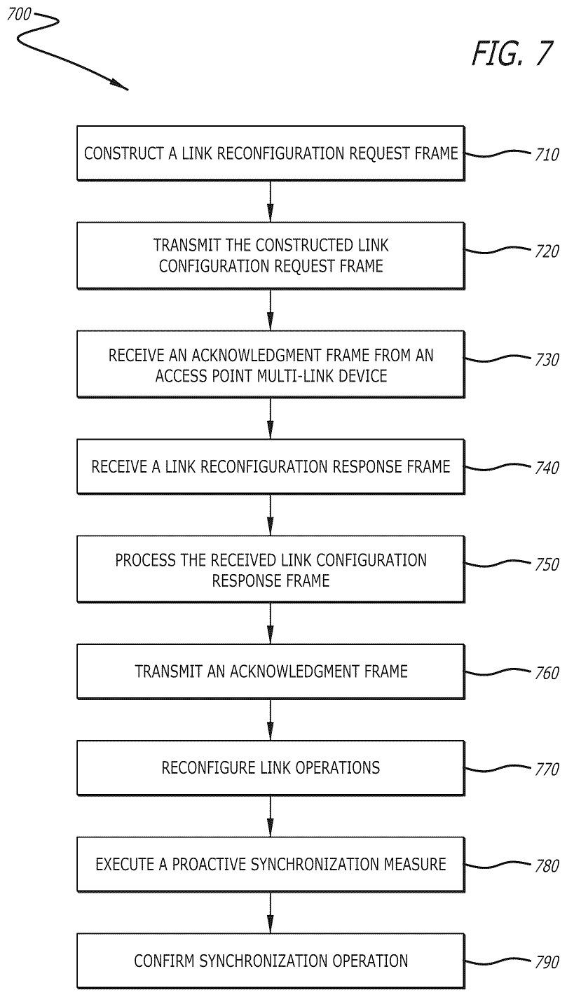

Referring to FIG. 7, a flowchart depicting a process 700 for non-access point multi-link device synchronization, in accordance with various embodiments of the disclosure is shown. The process 700 may illustrate a sequence of operations that a non-access point multi-link device (non-AP MLD) may perform to facilitate a robust multi-link reconfiguration, particularly when a current communication link is being deleted.

In many embodiments, the process 700 can construct a link reconfiguration request frame (block 710). The link reconfiguration request frame may be a management frame that specifies one or more links to be added to or deleted from the non-AP MLD's active set of communication links. For instance, the link reconfiguration request frame may propose the deletion of a current communication link on which the frame itself is being prepared for transmission. It is also contemplated that, in some embodiments, the link reconfiguration request frame may further comprise a preferred multi-link reconfiguration switch time proposed by the device to suggest a future time for the link changes to take effect.

In a number of embodiments, the process 700 can transmit the constructed link configuration request frame (block 720). This transmission may be directed from the non-AP MLD to an associated access point multi-link device (AP MLD) over a currently active wireless link. For example, in a scenario where the link reconfiguration proposes to delete the current link, this transmission may occur on that very link. In certain embodiments, the transmission may be sent as a protected management frame to ensure the security and integrity of the request.

In more embodiments, the process 700 can receive an acknowledgment frame from an access point multi-link device (block 730). This acknowledgment frame may serve as a confirmation that the previously transmitted link reconfiguration request frame was successfully received by the AP MLD. In some embodiments, this acknowledgment may be received prior to receiving a link reconfiguration response frame, serving as an intermediate confirmation in the overall transaction. It is contemplated that the link reconfiguration logic within the non-AP MLD may await this acknowledgment before proceeding to the next phase of the process.

In further embodiments, the process 700 can receive a link reconfiguration response frame (block 740). This response frame may be sent by the AP MLD and may indicate which of the requested link changes were approved. For instance, the link reconfiguration response frame may confirm the successful addition of a new link and the successful deletion of the current link. In some embodiments, the link reconfiguration response frame may also comprise a multi-link reconfiguration switch time, which may be set by the AP MLD to coordinate the exact time of the link transition.

In additional embodiments, the process 700 can process the received link configuration response frame (block 750). The processing may involve parsing the contents of the frame to determine the outcome of the request. For example, the link reconfiguration logic of the non-AP MLD may analyze the status codes for each requested link change to identify which links are now part of the new active set. In certain embodiments, if a switch time is included in the response, the logic may process this information to schedule the upcoming link transition.

In still more embodiments, the process 700 can transmit an acknowledgment frame (block 760). This acknowledgment frame may be sent from the non-AP MLD to the AP MLD to confirm the successful reception of the link reconfiguration response frame. This may be a critical part of the transaction, as the failure of the AP MLD to receive this acknowledgment can be the cause of the out-of-sync state that this disclosure seeks to prevent. In some embodiments, this acknowledgment may be the final message sent by the non-AP MLD on the link that is being deleted.

In yet further embodiments, the process 700 can reconfigure link operations (block 770). This transition may involve the non-AP MLD ceasing all communication on the link or links that were successfully marked for deletion in the response frame. Concurrently, the non-AP MLD may activate and begin operating on any newly added links. In some embodiments, if a multi-link reconfiguration switch time was provided in the response frame, the link reconfiguration logic may be configured to defer transitioning link operations until an expiration of that multi-link reconfiguration switch time.

In still additional embodiments, the process 700 can execute a proactive synchronization measure (block 780). This operation may be performed after transitioning link operations to ensure the AP MLD is aware of the non-AP MLD's updated state, especially in cases where the previous acknowledgment frame may have been lost. For instance, one embodiment of a proactive synchronization measure may comprise transmitting a frame with a power management bit set to zero on a newly added link to signal that the link reconfiguration was successful. It is also contemplated that this measure could involve responding to a synchronization attempt from the AP MLD, such as by receiving a retransmitted link reconfiguration response frame on a different link and transmitting an acknowledgment for it.

In yet more embodiments, the process 700 can confirm a synchronization operation (block 790). This may be the final stage of the process for the non-AP MLD, where its link reconfiguration logic confirms that its link state is consistent with that of the AP MLD. In some embodiments, this confirmation may be implicit upon the successful execution of the proactive synchronization measure. In other embodiments, this could involve receiving a final confirmation message from the AP MLD, after which the process for the non-AP MLD may conclude, having successfully and robustly reconfigured its links.

Although a specific embodiment for a process 700 for non-access point multi-link device synchronization for carrying out the various steps, processes, methods, and operations described herein is discussed with respect to FIG. 7, any of a variety of systems and/or devices may be utilized in accordance with embodiments of the disclosure. For example, the proactive synchronization measure could involve sending a specific type of management frame, such as a BSS Transition Management (BTM) response frame, to indicate its current operational state. The elements depicted in FIG. 7 may also be interchangeable with other elements of FIGS. 1-6 and FIGS. 8-9 as required to realize a particularly desired embodiment.

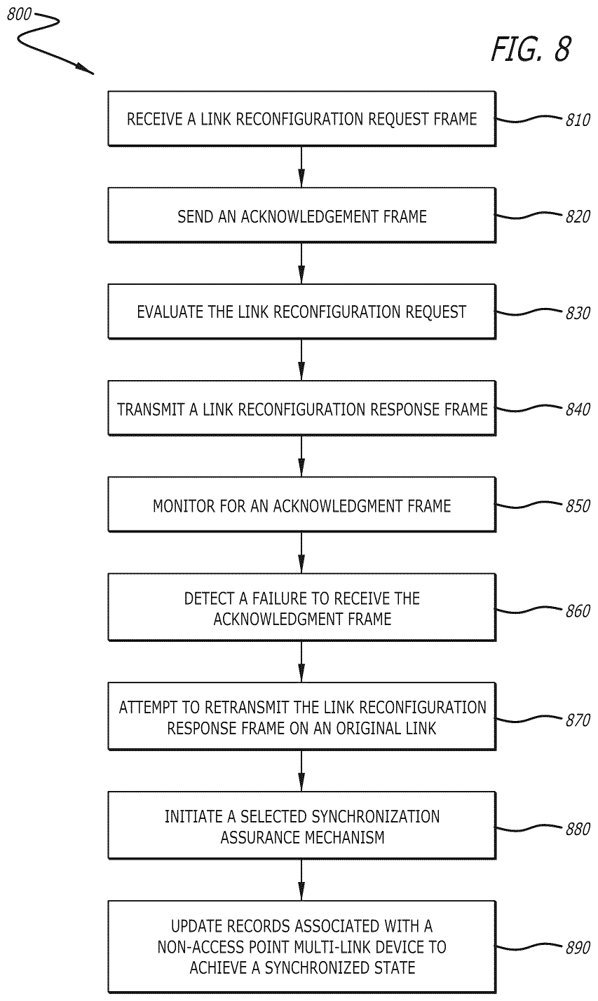

Referring to FIG. 8, a flowchart depicting a process 800 for access point multi-link device synchronization, in accordance with various embodiments of the disclosure is shown. The process 800 may illustrate a sequence of operations that an access point multi-link device (AP MLD) may perform to manage a link reconfiguration, handle potential communication failures, and ensure a synchronized link state with an associated non-access point multi-link device (non-AP MLD).

In many embodiments, the process 800 can receive a link reconfiguration request frame (block 810). This frame may be received from a non-AP MLD over a currently active wireless communication link. In certain embodiments, the received link reconfiguration request frame may propose the deletion of the original link on which the request frame itself was received, presenting a specific challenge for maintaining synchronization.

In a number of embodiments, the process 800 can send an acknowledgment frame (block 820). This acknowledgment frame may be transmitted back to the non-AP MLD on the same link where the request was received. For instance, this acknowledgment can serve to confirm to the non-AP MLD that its request has been successfully received by the AP MLD and is pending evaluation.

In more embodiments, the process 800 can evaluate the link reconfiguration request (block 830). The evaluation may involve the AP MLD's link reconfiguration logic assessing the proposed link changes against its own policies, current network load, and resource availability. For example, the logic may determine if the requested new links are available and if deleting the proposed link is acceptable from a network management perspective. It is contemplated that this evaluation could also involve communication with a central network controller.

In further embodiments, the process 800 can transmit a link reconfiguration response frame (block 840). This response frame may be sent to the non-AP MLD and may contain the AP MLD's decision regarding the requested link changes. In some embodiments, the transmitted link reconfiguration response frame may further comprise a multi-link reconfiguration switch time field that indicates a future time for the link reconfiguration to become active, thereby providing a coordinated window to handle potential retries.

In additional embodiments, the process 800 can monitor for an acknowledgment frame (block 850). After transmitting the response frame, the AP MLD's link reconfiguration logic may start monitoring for a corresponding acknowledgment from the non-AP MLD. For instance, this monitoring can be implemented with a timer that is initiated upon transmission of the response. In certain embodiments, the monitoring process may also be configured to listen for other types of frames from the non-AP MLD that could serve as an implicit confirmation of the transaction.

In still more embodiments, the process 800 can detect a failure to receive the acknowledgment frame (block 860). A failure may be detected if the timer initiated during the monitoring phase expires before the expected acknowledgment frame is received. This detection may be the critical trigger indicating a potential out-of-sync condition, as the AP MLD can no longer be certain that the non-AP MLD successfully processed the response frame.

In yet further embodiments, the process 800 can attempt to retransmit the link reconfiguration response frame on an original link (block 870). This may be a standard recovery attempt to address transient communication issues that may have caused the loss of the original response or the subsequent acknowledgment. However, this attempt may not succeed if the received link reconfiguration request frame had proposed the deletion of the original link and the non-AP MLD has already ceased operating on it.

In still additional embodiments, the process 800 can initiate a selected synchronization assurance mechanism (block 880). This mechanism may be initiated in response to the detected failure to ensure a consistent link state. For example, the selected synchronization assurance mechanism may comprise re-transmitting the link reconfiguration response frame on a newly added link that was indicated as successfully added in the response frame. It is also contemplated that the mechanism may comprise transmitting a BSS Transition Management (BTM) request frame that indicates a desired set of setup links, or it may involve interpreting a received frame with a Power Management (PM) bit set to zero on a new link as a confirmation of success.

In yet more embodiments, the process 800 can update records associated with a non-access point multi-link device to achieve a synchronized state (block 890). Following the successful execution of the synchronization assurance mechanism, the AP MLD's link reconfiguration logic may update its internal state information for the non-AP MLD. This may ensure that both devices have a consistent and accurate understanding of the active communication links, thus preventing future communication errors.

Although a specific embodiment for a process 800 for access point multi-link device synchronization for carrying out the various steps, processes, methods, and operations described herein is discussed with respect to FIG. 8, any of a variety of systems and/or devices may be utilized in accordance with embodiments of the disclosure. For example, instead of a single AP MLD, a group of coordinated AP MLDs operating as a system could collectively execute the process to manage client link reconfigurations. The elements depicted in FIG. 8 may also be interchangeable with other elements of FIGS. 1-7 and 9 as required to realize a particularly desired embodiment.

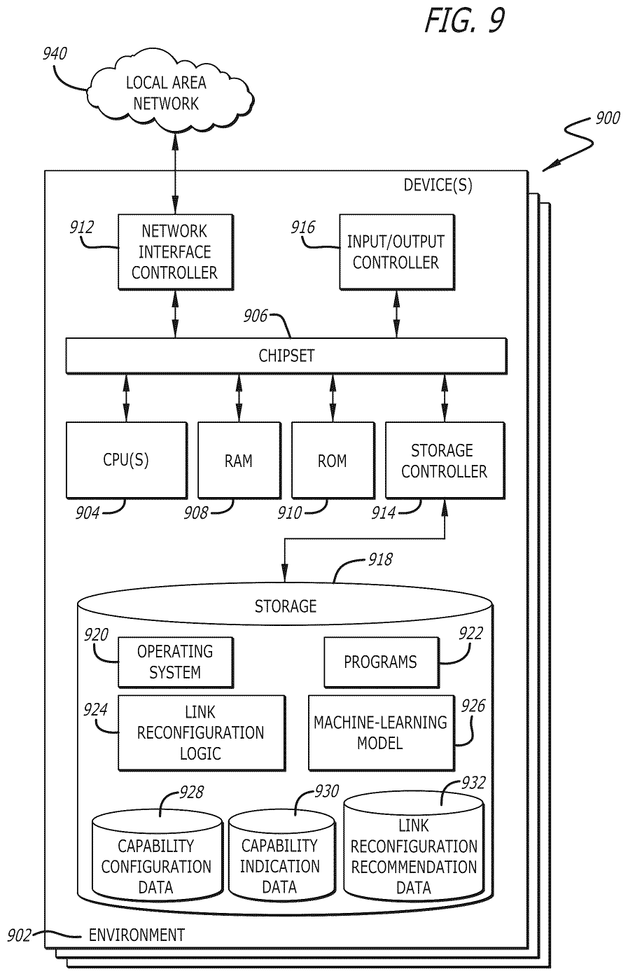

Referring to FIG. 9, a conceptual block diagram of a device 900 suitable for configuration with a link reconfiguration logic 924, in accordance with various embodiments of the disclosure is shown. The embodiment of the conceptual block diagram depicted in FIG. 9 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many non-limiting examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, processor(s) 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (RAM 908), which can be used as the main memory in the device 900 in some embodiments. The chipset 906 can further be configured to provide an interface to a computer-readable storage medium such as a read-only memory (ROM 910) or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (NIC 912), which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, applications 922, capability configuration data 928, capability indication data 930, and link reconfiguration recommendation data 932. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by a device 900 or multiple operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as applications 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-7. In certain embodiments, the device 900 can also include computer-readable storage media having instructions stored thereupon for performing any of the other computer-implemented operations described herein.

In many embodiments, the link reconfiguration logic 924 may be a central component responsible for executing the methods and processes for managing multi-link reconfigurations and ensuring synchronization between devices. When operating on a non-access point multi-link device, the link reconfiguration logic 924 may be configured to construct a link reconfiguration request frame, which may propose the deletion of a current communication link, and subsequently transmit the link configuration request frame. Conversely, when operating on an access point multi-link device, the link reconfiguration logic 924 may be configured to receive the link configuration request frame and evaluate the link reconfiguration request. In both roles, the logic may manage the stateful, time-sensitive exchange of request, response, and acknowledgment frames to facilitate robust link transitions.

In further embodiments, the link reconfiguration logic 924 may be configured to handle error conditions and maintain state consistency. For instance, on an access point multi-link device, the logic may be configured to monitor for an acknowledgment frame and, upon detecting a failure to receive the acknowledgment frame, attempt to retransmit the link reconfiguration response frame on an original link. If this fails or if policies dictate, the link reconfiguration logic 924 may be configured to initiate a selected synchronization assurance mechanism. On a non-access point multi-link device, after it has transmitted an acknowledgment frame and performed a transition of its link operations, the link reconfiguration logic 924 may be configured to execute a proactive synchronization measure to help confirm the outcome of the transaction with its associated access point multi-link device.

In some embodiments, the capability configuration data 928 may be a data store that contains the parameters and policies governing a device's multi-link operations. This data may define the device's supported features, operational constraints, and preferences related to link management. For example, the capability configuration data 928 may specify the set of available frequency bands, the maximum number of simultaneous links supported, and security protocols for each link. The link reconfiguration logic 924 may consult this data when preparing to construct a link reconfiguration request frame, ensuring the proposed changes are consistent with the device's configured capabilities.

In additional embodiments, the capability configuration data 928 may also store settings related to the various synchronization and recovery procedures. For instance, a device may store a preferred multi-link reconfiguration switch time that it can propose in a request frame to allow for a more predictable link transition. It is also contemplated that the capability configuration data 928 could contain flags or timers that define the behavior of a proactive synchronization measure, such as how long to wait after transitioning link operations before transmitting a frame with a power management bit set to zero to confirm the new state.

In certain embodiments, the capability indication data 930 may be a data store used to maintain the last-known state and capabilities of associated peer devices. For an access point multi-link device, this data store may be configured to hold a record for each associated non-access point multi-link device, detailing the set of links that are understood to be active and operational for that client. When the access point multi-link device receives a management frame, the link reconfiguration logic 924 may be parsed for any capability information and update the capability indication data 930 accordingly.

In various embodiments, the capability indication data 930 may be essential for detecting and resolving out-of-sync conditions. After an access point multi-link device has detected a failure to receive an acknowledgment frame, the stored capability indication data 930 for a client may no longer be accurate. The purpose of initiating a selected synchronization assurance mechanism may be to obtain a confirmed, updated status from the client. Upon successful completion of the recovery procedure, the access point multi-link device can update records associated with a non-access point multi-link device, which may be stored in the capability indication data 930, to achieve a synchronized state.

In a number of embodiments, the link reconfiguration recommendation data 932 may be a data store that contains the specific details of a proposed or approved link reconfiguration. When a non-access point multi-link device decides to initiate a link change, the link reconfiguration logic 924 may be utilized to generate the details of the change, such as which links to add and which links to delete, and store this information as link reconfiguration recommendation data 932 before constructing the link reconfiguration request frame. This data may represent the desired future state of the device's links.

In more embodiments, this data store may also be used by an access point multi-link device. After it evaluates a link reconfiguration request, the link reconfiguration logic 924 may formulate its response, which may include the approved changes, and store these details in the link reconfiguration recommendation data 932. Furthermore, in some recovery procedures, such as when a BSS Transition Management (BTM) request frame is used, the link reconfiguration recommendation data 932 may store the desired set of setup links that the access point multi-link device is recommending to the client to force a synchronized state.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, input/output controllers 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

Finally, in numerous additional embodiments, data may be processed into a format usable by one or more machine-learning models 926 (e.g., feature vectors), and or other pre-processing techniques. The one or more machine-learning models 926 may be any type of machine-learning model, such as supervised models, reinforcement models, and/or unsupervised models. The one or more machine-learning models 926 may include one or more of linear regression models, logistic regression models, decision trees, Naïve Bayes models, neural networks, k-means cluster models, random forest models, and/or other types of models.

In some embodiments, the one or more machine-learning models 926 may be utilized to enhance the intelligence and efficiency of the multi-link reconfiguration process. A machine-learning model may be trained on historical network performance data, traffic patterns, and link quality metrics to predict improved or near-optimal times or conditions for initiating a link reconfiguration. For example, the link reconfiguration logic 924 could consult an inference from the one or more machine-learning models 926 to decide whether to construct a link reconfiguration request frame to move to a less congested link before performance degrades noticeably.

In certain embodiments, the one or more machine-learning models 926 may also be applied to improve the error recovery process. When a failure to receive an acknowledgment frame is detected, a machine-learning model could analyze the context of the failure, including the link quality at the time of the message loss, the client device type, and the success rates of previous recovery attempts. Based on this analysis, the one or more machine-learning models 926 may provide an inference to the link reconfiguration logic 924 that suggests the most effective selected synchronization assurance mechanism to initiate, such as whether it is more efficient to re-transmit on a new link or to use a BTM request frame.

In summary, devices, networks, systems, methods, and processes for dynamically proxying traffic between interconnects of devices in a fabric are described herein. A communication network may include multiple switches, including gateway switches and non-gateway switches. Each switch can run a proxy agent for each port of the switch and for each link on each port. The switch may proxy data traffic within the communication network by utilizing the proxy agent. A non-gateway switch can send a connection request to a gateway switch to connect to an external cloud controller. The gateway switch may proxy the connection request to the external cloud controller and receive a session cookie. The non-gateway switch can establish a logical connection with the external cloud controller based on the session cookie.

Although a specific embodiment for a device suitable for configuration with a link reconfiguration logic 924 for carrying out the various steps, processes, methods, and operations described herein is discussed with respect to FIG. 9, any of a variety of systems and/or processes may be utilized in accordance with embodiments of the disclosure. For example, the device may be in a virtual environment such as a cloud-based network administration suite, or it may be distributed across a variety of network devices or switches in a current or already preferred future state. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one network interface controller configured to provide access to a network via a plurality of ports; and
a memory communicatively coupled to the processor, wherein the memory comprises a link reconfiguration logic that is configured to:
construct a link reconfiguration request frame;
transmit the link configuration request frame;
receive a link reconfiguration response frame;
process the received link configuration response frame;
transmit an acknowledgment frame; and
reconfigure one or more link operations.

2. The device of claim 1, wherein the link reconfiguration logic is further configured to receive an acknowledgment frame prior to receiving a link reconfiguration response frame.

3. The device of claim 2, wherein the acknowledgment frame is received from an access point multi-link device.

4. The device of claim 1, wherein the link reconfiguration logic is further configured to execute a proactive synchronization measure after reconfiguring the one or more link operations.

5. The device of claim 4, wherein the link reconfiguration logic is further configured to confirm a synchronization operation upon executing the proactive synchronization measure.

6. The device of claim 4, wherein the proactive synchronization measure comprises transmitting a frame with a power management bit set to zero on a newly added link to signal that a link reconfiguration was successful.

7. The device of claim 1, wherein the link reconfiguration request frame proposes deletion of a current communication link on which a link configuration request frame is transmitted.

8. The device of claim 7, wherein the link reconfiguration request frame further comprises a preferred multi-link reconfiguration switch time proposed by the device.

9. The device of claim 1, wherein the link reconfiguration response frame comprises a multi-link reconfiguration switch time.

10. The device of claim 9, wherein the link reconfiguration logic is further configured to defer transitioning link operations until an expiration of the multi-link reconfiguration switch time.

11. The device of claim 1, wherein the link reconfiguration logic is further configured to:
receive a retransmitted link reconfiguration response frame on a different link than a link where the link reconfiguration request frame was sent; and
transmit an acknowledgment for the retransmitted link reconfiguration response frame.

12. The device of claim 1, wherein the link reconfiguration logic is further configured to:
receive a BSS Transition Management (BTM) request frame from an access point multi-link device after transitioning link operations; and
transmit a BTM response frame indicating a status that the device is already operating on a set of suggested links included in the BTM request frame.

13. A device, comprising:
a processor;
at least one network interface controller configured to provide access to a network via a plurality of ports; and
a memory communicatively coupled to the processor, wherein the memory comprises a link reconfiguration logic that is configured to:
receive a link configuration request frame comprising a link reconfiguration request;
transmit an acknowledgment frame;
evaluate the link reconfiguration request;
transmit a link reconfiguration response frame;
monitor for an acknowledgment frame;
detect a failure to receive the acknowledgment frame;
attempt to retransmit the link reconfiguration response frame on an original link; and
initiate a selected synchronization assurance mechanism.

14. The device of claim 13, wherein the link reconfiguration logic is further configured to update records associated with a non-access point multi-link device to achieve a synchronized state.

15. The device of claim 13, wherein the received link reconfiguration request frame proposes a deletion of the original link on which the link reconfiguration request frame was received.

16. The device of claim 13, wherein the selected synchronization assurance mechanism comprises re-transmitting the link reconfiguration response frame on a newly added link that was indicated as successfully added in the link reconfiguration response frame.

17. The device of claim 13, wherein the selected synchronization assurance mechanism comprises transmitting a BSS Transition Management (BTM) request frame to a non-access point multi-link device, wherein the BTM request frame indicates a desired set of setup links.

18. The device of claim 13, wherein the selected synchronization assurance mechanism comprises:
receiving a frame with a Power Management (PM) bit set to zero on a newly added link from a non-access point multi-link device; and
interpreting the frame as a confirmation that a link reconfiguration was successful.

19. The device of claim 13, wherein the link reconfiguration response frame further comprises a multi-link reconfiguration switch time field that indicates a future time for a link reconfiguration to become active, wherein a switch time provides a duration for a non-access point multi-link device to remain on the original link to receive the retransmitted link reconfiguration response frame.

20. A method of facilitating improved multi-link reconfiguration, the method comprising:
constructing a link reconfiguration request frame;
transmitting a link configuration request frame;
receiving a link reconfiguration response frame;
processing the received link configuration response frame;
transmitting an acknowledgment frame; and
transitioning link operations.
